(19) United States
(12) Patent Application Publication
(10) Pub. No.: US 2022/0157133 A1
(43) Pub. Date: May 19, 2022

(54) AN AUTOMATED SELF SERVICE SYSTEM

(71) Applicant: MACTUZ ROBOTICS SDN. BHD., Petaling Jaya,Selangor Darul Ehsan (MY)

(72) Inventor: Chung Onn LAI, Wilayah Persekutuan Kuala Lumpur (MY)

(73) Assignee: MACTUZ ROBOTICS SDN. BHD., Petaling Jaya,Selangor Darul Ehsan (MY)

(21) Appl. No.: 17/439,534

(22) PCT Filed: Mar. 13, 2020
(86) PCT No.: PCT/MY2020/000004

§ 371 Date: Sep. 15, 2021

(30) Foreign Application Priority Data
Jan. 3, 2021 (MY) PI 2019001657

(51) Int. Cl. G07F 19/00; G06Q 20/10; G05D 1/02; B60L 50/60

(52) U.S. Cl. CPC G07F 19/205; G06Q 20/1085; G06Q 20/3223; G05D 1/0214; B60L 50/60; G07F 19/211

(57) ABSTRACT

The present invention provides a self-service system (100) comprises: at least one mobile robot (110) for providing the services; and a cloud server (140) in communication with the at least one mobile robot (110) and a plurality of user mobile devices (180) via a communication network, characterised in that the cloud server (140) comprises: a queue management module (141) configured to generate a digital queue number to a designated user mobile device (180) upon receiving a request; and a robot management system (142) configured to manage activities of the mobile robot (110) in accordance to the sequence of the generated digital queue numbers, wherein the system (100) further comprises a means to guide the mobile robot (110) to the designated position of the user mobile device (180).

### FIELD OF THE INVENTION

This invention relates to a self service system and more particularly, to an automated self service system.

### BACKGROUND OF THE INVENTION

Banking today no longer means just going to the bank and standing in line, it's about transacting wherever and whenever your customers choose. The amount of financial services has developed rapidly, and more customers choosing to do bank transactions on a self service system such as an automated teller machine (ATM) instead of standing in line in the banks waiting for their turns at cashier or teller counter where a person in the counter assists them.

These ATMs permits the customer's withdrawal of cash, balance inquiry etc. by which financial transactions and inquiries can be initiated on it. Due to this, human interaction is no longer required for the bank transaction in the banks. It's quick and easy transactions on the ATM and for the banks this means freeing up your tellers' time so they can focus more of their efforts on high-value activities. These ATMs enables the customers to do more for themselves, allows the banks to optimize their teller resources.

There are several prior arts disclosing the bank self service system, some of which are listed below for reference. The United States granted U.S. Pat. No. 5,915,246A discloses an unattended self-service terminal connectable to a host system and for allowing a self-service customer to carry out a self-service transaction, the self-service terminal comprising: input means for receiving customer identifying information from the self-service customer; a display means for displaying sales information to be viewed by the self-service customer; a storage means for storing a plurality of sales presentations which are viewable by the self-service customer; an queue sensing means for sensing a queue of potential self-service customers adjacent to the self-service terminal and providing a signal indicative thereof; and a control means for selecting one of the plurality of sales presentations based upon the customer identifying information received from the self-service customer and the signal from the queue sensing means to display the selected sales presentation on the display means to provide sales information to be viewed by the self-service customer.

Another cited prior art, the China Patent Application number CN101000702A discloses a bank self-service method for self-service terminal comprising a bank, a background server and network banking self-service system, characterized by comprising: a step, by the bank kiosk interface display to select the desired self-service items; Step Second, the card is read in the IC card user's personal identification information is provided by the self-service terminal in a bank card reader; step three, characterized by the body disposed on the bank kiosk collecting apparatus obtains the user's body in real time biometric information; step four, back-office services to the end user's personal identification information obtained judgment and identify biometric information, provide further allow for legitimate users to provide further selected self-service transaction interface, the invalid users rejected transaction interface; step five, the bank self-service terminal sends a transaction request to the backend server, the server in response to the background processing provides an interface for the transaction to complete the authorized user self-service.

The drawbacks of above mentioned self service system are the customer has to look for the location of the ATM machine and further usually requires long time to wait in the queue standing. Furthermore, the current ATMs provides only limited banking services for the customers. And the customer still has to approach existing teller counter service for additional services which is also tiring and troublesome.

None of the above-cited prior arts discloses such a self service system having a mobile robot that can locate the customer who requested for the service and travels to the designated customer to attend the customer's request.

### SUMMARY OF THE INVENTION

The present invention provides a self-service system comprises: at least one mobile robot to provide the services; and a cloud server in communication with the at least one mobile robot and a plurality of user mobile devices via a communication network, characterised in that the cloud server comprises: a queue management module configured to generate a digital queue number to a designated user mobile device upon receiving a request; and a robot management system configured to manage activities of the mobile robot in accordance to the sequence of the generated digital queue numbers, wherein the system further comprises a means to guide the mobile robot to the designated position of the user mobile device.

Preferably, the system provides a self-banking service.

Preferably, the mobile robot comprises: a main body; a wheel drive system beneath the main body; a user interface platform mounted on top of the main body to facilitate interaction with users; and a plurality of external devices, configured to register and verify user identity details.

Preferably, the user interface platform comprises: a processor; and a display unit, configured to display the user details.

Preferably, the plurality of external devices includes cash in and cash out module, card dispenser, card reader, biometric reader, payment terminal, pinpad, camera, printer, scanner, passport scanner, coin in and coin out module, barcode reader or any combination thereof.

Preferably, the user interface platform is in the form of smart mobile device.

Preferably, the processor is a customizable application processor allowing the mobile robot to communicate with different types of external devices.

Preferably, the wheel drive system includes a motor powered by a battery.

Preferably, the system further comprising a charging station where the mobile robot can recharge the battery.

Preferably, the mobile robot further comprises a sensor to detect obstacles and to prevent collision.

Preferably, the sensor and the motor are controlled by the processor.

Preferably, the user mobile devices are personal digital assistants (PDA), smart phones, tablets, laptops, netbooks, phablets, phoblets or any suitable means which capable of processing data and performing data transmission.

Preferably, the user mobile devices are each installed with an application module configured to establish communication link with the cloud server via the communication network and to generate and transmit the request for obtaining the digital queue number.

Preferably, the communication network is formed by a plurality of network nodes programmed to carry out an indoor positioning protocol for detecting the location of the connected user mobile devices and the mobile robot.

Preferably, the means is a location tracker and navigation module configured to determine position of the user mobile device through the communication network and guides the mobile robot to the designated position of the user mobile device based on the sequence of the digital queue number.

### BRIEF DESCRIPTION OF DRAWINGS

These and other features, aspects, and advantages of the present invention will become better understood, when the following detailed description is read with reference to the accompanying drawings in which like characters represent like parts throughout the drawings, wherein:

FIG. 1 is a block diagram of a self service system, in accordance to a preferred embodiment of the present invention.

FIG. 2 is a block diagram of hardware module architecture of a robot, in accordance to an embodiment of the present invention.

FIG. 3 is a block diagram of software module arrangement of the self service system in accordance to an embodiment of the present invention.

FIG. 4 illustrates a working model of the robot 4a. Isometric view of the robot; 4b. Side view of the robot and 4c. Front view of the robot, in accordance to a preferred embodiment of the present invention.

FIG. 5 is a flow chart showing process steps to use the self service system, in accordance to a preferred embodiment of the present invention.

### DETAILED DESCRIPTION OF THE INVENTION

The present invention discloses a self service system that can be used in any service sectors which includes but not limited to food & beverage sector, entertainment sector, retail sector, banking sector, travel & hospitality sector, medical sector, insurance sector, automobile sector and any other service sectors known in the art. By way of example, the present invention is now explained with the use of the self service system in a banking sector.

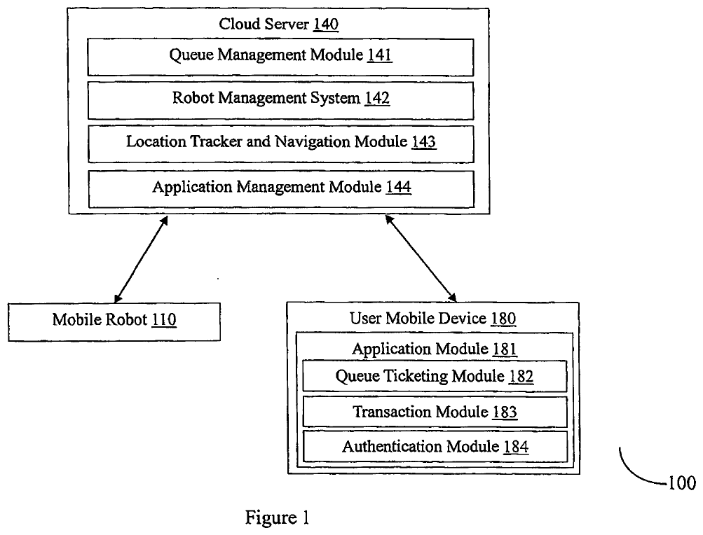

FIG. 1, illustrates the self service system (100) comprises: a mobile robot (110), a cloud server (140) and a plurality of user mobile devices (180).

The user mobile device (180) can be a personal digital assistants (PDA), smart phones, tablets, laptops, netbooks, phablets, phoblets or any suitable devices which are capable of data processing and performing data transmission.

In a preferred embodiment, the user mobile device (180) is a smart phone device installed with an application module (181). The user mobile device (180) can include display means, a communication means, a location tracker means and an input means. The user is required to register the details to log in with the application module (181) via the input means required to generate a service request. The application module (181) may provide a virtual form for the user to provide the details related for the request. Further, the application module (181) can include a virtual button for the user to submit the details and generate the request. Furthermore, the application module (181) is configured to establish communication link with the cloud server (140) via a communication network and transmit the request along with the details to the cloud server (140).

The application module (181) preferably includes a queue ticketing module (182), a transaction module (183) and an authentication module (184). The queue ticketing module (182) is configured to communicate with the cloud server (140) and assist to obtain a digital queue number from the cloud server (140) for the request submitted. Further, the queue ticketing module (182) is also configured to provide the user about current status on the ongoing queue number and update the user upon the turn. The transaction module (183) is configured to allow the user to do transaction from their own user mobile device (180). Preferably, the transaction module (183) is configured to provide support for any transactional operations via the user mobile device (180). The authentication module (184) is configured to authenticate the identity of the user prior to submission of the request and the transaction to be made. Preferably, the authentication module (184) is configured to provide any kind of security check to verify the user identity details.

The cloud server (140) can be a virtual server (rather than a physical server) running in a cloud computing environment. It can be built, hosted and delivered via a cloud computing platform via the internet, and can be accessed remotely by the user mobile device (180). The cloud server (140) comprises of a queue management module (141), a robot management system (142), a location tracker & navigation module (143) and an application management module (144).

The queue management module (141) is configured to receive the request from the user mobile device (180) and generate the digital queue number for the received request in a sequential order. Preferably, the queue management module (141) is configured to generate the digital queue number on the basis of first come first serve. Further, the queue management module (141) is configured to transmit the generated digital queue number to the user mobile device (180) for the user reference and to the robot management system (142). Preferably, the queue management module (141) is configured to analyze the type of the request and sort the request based on the precedence. Based the sorted results the queue management module (141) is configured to generate the digital queue number.

The robot management system (142) configured to manage activities of the mobile robot (110) in accordance to the sequence of the generated queue numbers. Preferably, the robot management system (142) is configured to communicate and assign the mobile robot (110) for the each request. Preferably, the robot management system (142) is configured to assign the mobile robot (110) for the each request in accordance to sequential order of the generated digital queue number. Further, the robot management system (142) is configured to trigger the assigned mobile robot (110) to attend to the request.

The location tracker and navigation module (143) is configured to determine position or location details of the user mobile device (180) for the each request in accordance to the sequential order of the digital queue number. Further, the location tracker and navigation module (143) is configured to transmit the determined location details to the assigned mobile robot (110). Preferably, the location tracker and navigation module (143) is configured to generate a shortest path for the mobile robot (110) to travel towards the designated location of the user mobile device (180).

The application management module (144) is configured to control and manage the usage of the application module (181) installed in the user mobile device (180). Preferably, the application management module (144) is configured to generate detailed logs, application statistics and complete analysis report which can assist administrator to understand the user behavior based on the usage of the application module (181). Further, the application management module (144) is configured to block the user from usage of the application module (181) based on the user behavior if found that the application module (181) is misused.

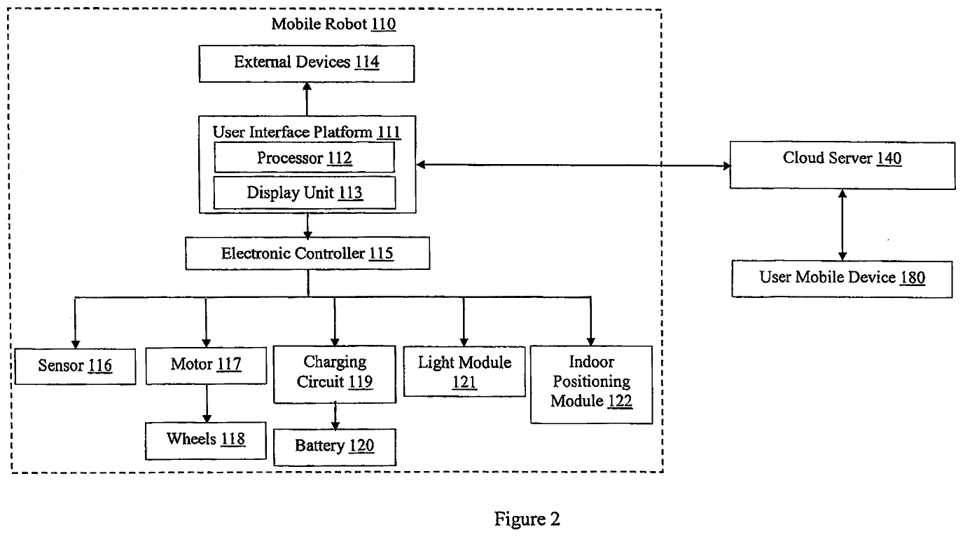

FIG. 2 illustrates the hardware module architecture of the mobile robot. The mobile robot (110) is preferably located within the bank premises and comprises of a main body, a user interface platform (111), a plurality of external devices (114), an electronic controller (115), a plurality of sensors (116), a wheel drive system, a light module (121), a charging circuit (119) and a battery (120). The mobile robot (110) is preferably configured to receive instructions along with location details from the cloud server (140) to travel towards the designated user mobile device (180) and attend to the user's request.

The main body can be in any kind of shape configuration. It is preferably provided with a mount to receive the user interface platform (111) into it. The user interface platform (111) is connected to the charging circuit (119) and the battery (120) via the electronic controller (115). The charging circuit (119) is configured to charge the battery (120) from a power source and supply power to the user interface platform (111). The wheel drive system preferably can include a plurality of wheels (118) and a motor (117). The wheels (118) are arranged beneath the main body and connected to the motor (117). Preferably, the motor (117) is powered by the battery (120).

The system (100) further comprises a charging station, where the mobile robot (110) is configured to travel to the charging station to recharge the battery (120) upon low battery detection. Preferably, the mobile robot (110) further includes a power level detection means connected to the battery (120) is configured to detect the level of charge in the battery (120). Further, the light module (121) is configured to blink or flash the light signal upon the low battery detected.

The user interface platform (111) is provided to facilitate interaction with the users. Preferably, the user interface platform (111) is in the form of smart mobile device or a computing device comprises a processor (112), a display unit (113), and an input means. The processor (112) is connected with the display unit (113) and with the external device (114) is configured to control the operations of the both.

The processor (112) is configured to communicate with various types of external devices (114) arranged in the mobile robot (110). The user can interact with the mobile robot (110) via the input means and the display unit (113). Further, the processor (112) is also configured to control the various hardware modules as mentioned above via the electronic controller (115). Preferably, the processor (112) is connected to the light module (121) via the electronic controller (115) and configured the provide instructions to the electronic controller (115) to control the operations of the light module (121). The processor (112) is also connected with the motor (117) via the electronic controller (115). Preferably, the processor (112) is configured to control the operations of the motor (117) to drive the wheels (118) along the path by providing the necessary instructions to the electronic controller (115) to operate the motor (117). Further, the processor (112) is also configured to control the operations of the charging circuit (119) by providing the instructions to the electronic controller (115).

The external devices (114) preferably can include cash in and cash out module, card dispenser, card reader, biometric reader, payment terminal, pinpad, camera, printer, scanner, passport scanner, coin in and coin out module, barcode reader or any other suitable devices used in banking related services.

The external devices (114) are provided on the main body of the mobile robot (110) to facilitate in opening of a bank account for the user. For an example, the external device (114) such as a camera is configured to record facial images of the user interacting with the mobile robot (110). Preferably, the camera is connected to an image detection module to store and verify the identity details of the user. The scanner is configured to scan an identification card to register the user details with the bank for verification purpose. Apart from the identification card scanner, preferably the passport scanner is also provided for the user identity verification. The passport scanner is configured to capture the user identity details from the passport and store the user identity details. The biometric reader is configured to collect the biometric details from the user. The biometric reader can be a fingerprint scanner, a facial scanner, an iris scanner and any other biometric devices known in the art. Upon successful registration, the card dispenser is configured to dispense a bank card for the user registered with the bank account.

Further, the external devices (114) are also configured to facilitate the user to carry out various transactions. For example the external devices (114) such as the card reader is provided with a slot to insert the card into the slot and is configured to read the card. The details of the card are displayed on the display unit. The pinpad is preferably an alphanumeric keypad is configured to allow the user enter the pin or password to access the bank account. The payment terminal is configured to establish secure payment link for the user and process the payment. The cash in and cash out module is configured to allow the user to deposit the cash into the bank account and cash out from the bank account. The coin in and coin out module configured to allow user to insert the coin into the mobile robot (110) and dispense the coin out from the mobile robot (110) for the payment purpose. The barcode reader is configured to scan the barcode and retrieve the user details from the barcode. Preferably, the barcode reader can be 2D or QR code format. Upon successful transaction, the printer is configured to print transaction details or the balance statement upon the transaction performed by the user.

Preferably, the plurality of sensors (116) are configured to detect obstacles and to prevent collision with the obstacles along the path for the mobile robot (110) designated to the travel towards to the user. Preferably, the sensor (116) is controlled by the processor (112) via the electronic controller (115). Based on the data from the sensor (116), the processor is configured to send instructions to the electronic controller (115) to control the operation of the motor (117) accordingly.

The communication network is formed by a plurality of network nodes programmed to carry out an indoor positioning protocol for detecting the location of the connected user mobile devices (180) and the mobile robot (110).

Preferably, the mobile robot (110) further comprises of an indoor positioning module (122) is a system configured to locate the user mobile device (180) inside the bank premises using lights, radio waves, magnetic fields, acoustic signals, or other sensory information. Preferably, the indoor positioning module (122) use technologies of distance measurement between nearby anchor nodes (nodes with known fixed positions, e.g. WiFi/LiFi access points or Bluetooth beacons), magnetic positioning and dead reckoning. Preferably, the indoor positioning module (122) is connected to the processor (112) via the electronic controller (115).

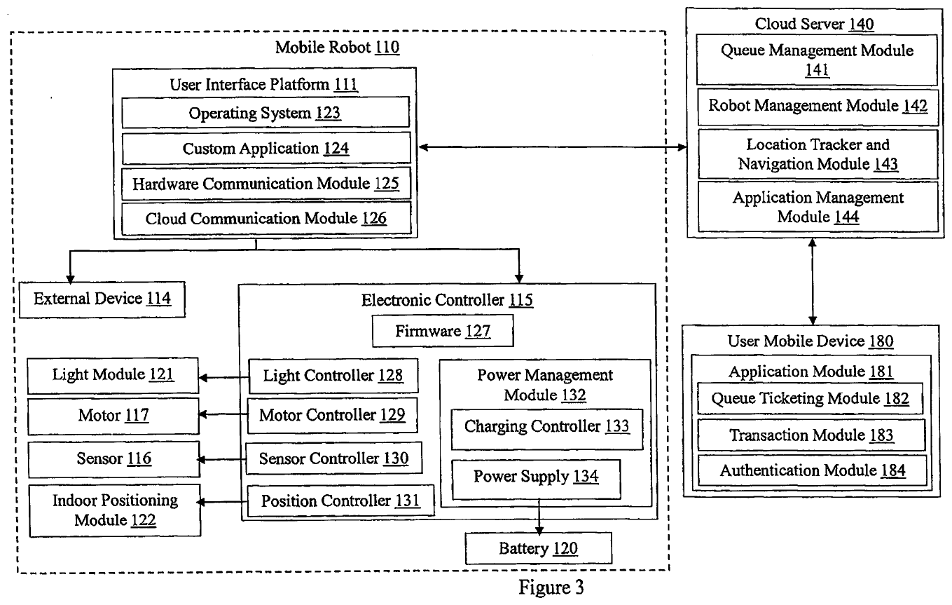

FIG. 3 illustrates the software architecture of the self service system. The user interface platform (111) further comprises of an operating system (123) and a custom application (124).

The user interface platform (111) is installed with the operating system (123) that manages the hardware modules and the software modules in the mobile robot (110). Preferably, the operating system (123) can include iOS, android, Mac, Ubuntu, Linux, Symbian, windows, OS X, Web OS, Chrome OS, Firefox OS and any other operating system known in the art. The processor (112) is preferably a customizable application processer installed with the customizable application (124).

Preferably, the user interface platform (111) is further installed with a hardware communication module (125) and a cloud communication module (126). The hardware communication module (125) is configured to establish communication links between the external devices (114) and the electronic controller (115) during the interaction with the user. The cloud communication module (126) is configured to establish link with the cloud server (140) to transmit data and receive the data from the cloud server (140).

Preferably, the electronic controller (115) is installed with various software modules which includes a firmware (127), a light controller (128), a motor controller (129), a sensor controller (130), a position controller (131) and a power management module (132). The firmware (127) is a software that provides the low-level control for the mobile robot's (110) specific hardware devices, preferably the light module (121) is controlled via the light controller (128). The motor (117) is controlled via the motor controller (129). The sensors (116) are controlled via the sensor controller (130). And the indoor positioning module (122) is controlled via the position controller (131). The power management module (132) includes a charging controller (133) to control the charging unit (133) and provide power supply (134) to the battery (120).

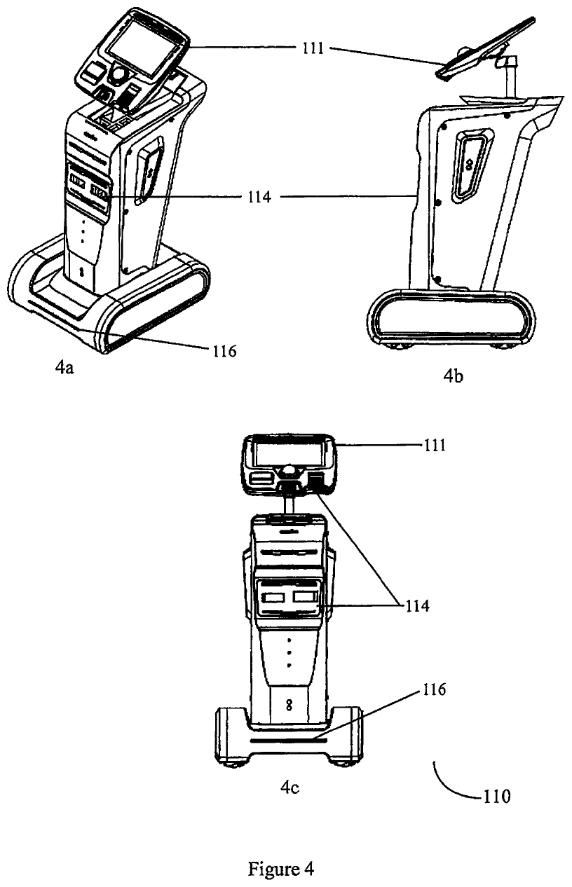

FIGS. 4a, 4b & 4c illustrates an isometric view, a side view and a front view of the mobile robot (110). The main body of the mobile robot (110) is preferably in rectangular shape configuration arranged on the wheel drive system. Preferably, the user interface platform (111) is arranged in a casing kind of configuration to protect the user interface platform (111) from any damage and secure the user interface platform (111) in the position. This casing kind of configuration is arranged on top of the main body via a connecting means which provides the user interface platform (111) to be rotatable and tiltable in any direction and angle on the main body. Preferably, a neck posture angle sensor is provided on the casing configured to detect the neck posture and face angle of the user while interacting with the user interface platform (111). The processor (112) based on the data from the neck posture angle sensor triggers instructions to the connecting means to rotate or the tilt the casing automatically to provide better interaction experience for the user. On the casing, preferably a set of the external devices (114) as above mentioned with respect to the FIG. 2 is arranged on it and is connected with the user interface platform (111) to work together. While another set of the external devices (114) are arranged on the main body and connected to the user interface platform (111). The sensors (116) are preferably arranged at bottom of the main body preferably near the wheel drive system is configured to sense any obstacle found along the path the mobile robot (110) scheduled to travel and transmits the sensed data to the processor (112). The mobile robot (110) is provided with a security module configured to security features from being theft. Preferably, the security module can include an alarm configured to provide an alarm sound upon any attempt to theft or damage the mobile robot (110). Further, the mobile robot (110) is also provided with a customer care service module configured to provide any kind of customer care services to the user preferably by an automated call services or question & answer form for the user to fill in.

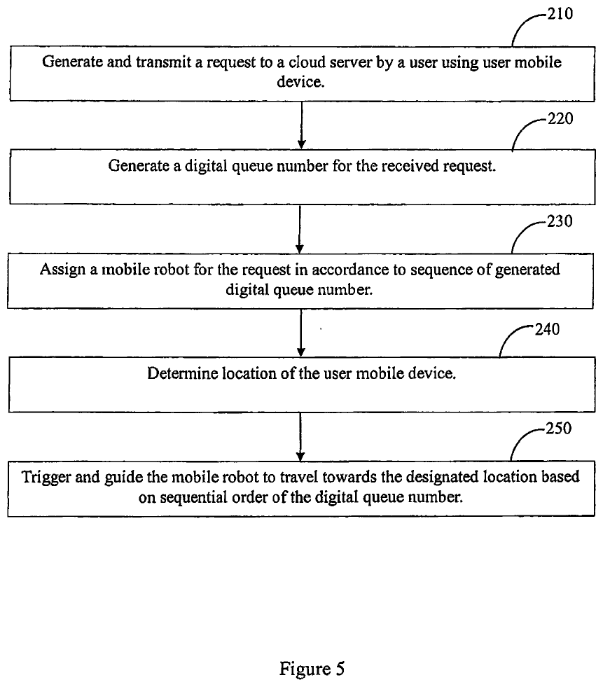

FIG. 5 is a flow chart which illustrates process steps (210 to 250) for using the self service system, the process comprising the steps of: launch the mobile application in the user mobile device (180), by the user. Then, (Step 210) fill in the necessary details in the mobile application by the user to generate the request. Then, transmit the generated request to the cloud server (140), by the user mobile device (180) via the application module (181). Next, (Step 220) generate the digital queue number, by the queue management module (141) for the request and transmit the generated digital queue number to the user mobile device (180) and to the robot management system (142), by the queue management system (141). Next, (Step 230) assign the mobile robot (110) for the each request by the robot management system (142) in accordance to sequence of the generated digital queue number. Then, (Step 240) determine position details of the user mobile device (180) by the location tracker & navigation module (143) and transmit the determined position details to the robot management system (142). Next, (Step 250) transmit the position details to the mobile robot (110) and based on sequential order of the digital queue number instruct the mobile robot (110) to travel the designated user mobile device (180) to attend the user's request.

Such request can include the bank account opening, cash deposits, cash withdrawals, transfers, money orders, account balance checking, issuing bank statement, loan payments, mortgages, transfers, wire transfer, check deposit, check cashing and any other services carried out by the teller in the bank.

In an alternative embodiment, the self service system (100) can include a plurality of transceiver devices configured to be registered or paired with the cloud server (140) for queuing the request. Each transceiver device is registered with the cloud server (140) by using a queue number and this queue number is updated to the cloud server (140). The transceiver device is preferably carried by the user within the premise. The transceiver device can include a display module, at least one button, a location module, a communication module and a vibrating means. The display module is configured to display the status on the current queue number. The button is configured for the user to trigger the request and transmit the request to the cloud server (140). The communication module is configured to establish communication link with the cloud server (140). The location module is configured to provide real time location details of the transceiver device and is transmitted to the cloud server (140). Further, the cloud server (140) transmits the location details to the mobile robot (110) for the mobile robot (110) to travel towards the designated user. The vibrating means is configured to notify the user upon the user's turn and the mobile robot (110) is approaching towards the user. The transceiver device can also include a signal emitting means which is configured to emit signal to be detected by the mobile robot (110) to track the location of the transceiver device. The mobile robot (110) further, can include a collection means configured to collect the transceiver device from the user before the user's request is attended.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1. A self-service system, comprising:
at least one mobile robot for providing the services; and
a cloud server in communication with the at least one mobile robot (110) and a plurality of user mobile devices via a communication network, wherein the cloud server further
comprises
a queue management module configured to generate one or more digital queue number to one or more designated user mobile devices (180) upon receiving one or more requests; and
a robot management system configured to manage activities of the mobile robot in accordance to a sequence of the generated digital queue numbers; and
a means to guide the mobile robot to a designated position of each user mobile device.

2. The system according to claim 1, wherein the system is further configured to provide a self-banking service.

3. The system according to claim 1, wherein the mobile robot further comprises:
a main body;
a wheel drive system beneath the main body;
a user interface platform mounted on top of the main body to facilitate interaction with users; and
a plurality of external devices, configured to register and verify user identity details.

4. The system according to claim 3, wherein the user interface platform further comprises:
a processor; and
a display unit, configured to display the user details.

5. The system according to claim 3, wherein the plurality of external devices includes at least one external device selected from the group consisting of a cash in and cash out module, a card dispenser, a card reader, a biometric reader, a payment terminal, a pinpad, a camera, a printer, a scanner, a passport scanner, a coin in and coin out module, a barcode reader, and combinations thereof.

6. The system according to claim 4, wherein the user interface platform is in the form of smart mobile device.

7. The system according to claim 4, wherein the processor is a customizable application processor allowing the mobile robot to communicate with different types of external devices.

8. The system according to claim 2, wherein the wheel drive system includes a motor powered by a battery.

9. The system according to claim 8, further comprising a charging station where the mobile robot can recharge the battery.

10. The system according to claim 4, wherein the mobile robot further comprises a sensor to detect obstacles and to prevent collision.

11. The system according to claim 2, wherein the sensor and the motor are controlled by the processor.

12. The system according to claim 1, wherein the user mobile devices are personal digital assistants (PDA), smart phones, tablets, laptops, netbooks, phablets, phoblets or any suitable means which capable of processing data and performing data transmission.

13. The system according to claim 12, wherein the user mobile devices are each installed with an application module configured to establish communication link with the cloud server via the communication network and to generate and transmit the request for obtaining the digital queue number.

14. The system according to claim 1, wherein the communication network is formed by a plurality of network nodes programmed to carry out an indoor positioning protocol for detecting the location of the connected user mobile devices and the mobile robot.

15. The system according to claim 1, wherein the means is a location tracker and navigation module configured to determine position of the user mobile device through the communication network and guides the mobile robot to the designated position of the user mobile device based on the sequence of the digital queue number.
